(19) United States
(12) Patent Application Publication
(10) Pub. No.: US 2026/0066384 A1
(43) Pub. Date: Mar. 5, 2026

(54) MULTI-FUNCTIONAL INTERLAYER FOR SUPERBEAM SUBCHANNEL IN VEHICLE BATTERY PACK

(71) Applicant: GM Global Technology Operations LLC, Detroit, MI (US)

(72) Inventors: Zhenwen Hu, Shanghai (CN); Alexander M. Bilinski, Avoca, MI (US); Phillip Daniel Hamelin, Holly, MI (US); Jian Yao, Shanghai (CN); Lu Huang, Troy, MI (US); Ryan Patrick Hickey, Austin, TX (US)

(21) Appl. No.: 18/829,885

(22) Filed: Sep. 10, 2024

(30) Foreign Application Priority Data
Sep. 4, 2024 (CN) 202411239932.1

(51) Int. Cl. H01M 10/6554; H01M 10/613; H01M 10/625; H01M 10/653; H01M 10/656; H01M 10/658

(52) U.S. Cl. CPC H01M 10/6554; H01M 10/613; H01M 10/625; H01M 10/653; H01M 10/658; H01M 10/656

(57) ABSTRACT

A battery for an electric vehicle is provided. The battery includes a battery pack housing, a battery pack carried by the battery pack housing, and a superbeam contained within the battery pack housing. The superbeam includes a first face plate, a first passenger plate that partially abuts the first face plate, a first subchannel defined by the first face plate and the first passenger plate, a second passenger plate, a thermal barrier interlayer disposed between the first passenger plate and the second passenger plate, a second face plate opposite the first face plate, a second subchannel defined by the second face plate and the second passenger plate, and an inlet port and an outlet port extending through the superbeam. A portion of the first passenger plate and a portion of the second passenger plate define an air gap. The thermal barrier interlayer extends into the air gap.

### INTRODUCTION

The present disclosure relates to a battery pack, and more particularly, to a vehicle battery pack having structural beams that function to provide cooling for the vehicle battery pack.

A rechargeable energy storage system (RESS) typically includes a plurality of electrode stacks or battery cells. The battery cells are placed next to one another typically in a case or enclosure to protect the battery cells from the ambient environment. The case also may contain an electrolyte, a separator, and other components within the case and around the electrode stacks.

### SUMMARY

According to several aspects of the present disclosure, a battery for an electric vehicle is provided. The battery includes a battery pack housing, at least one battery pack carried by the battery pack housing, and at least one superbeam contained within the battery pack housing. The at least one superbeam has an elongated body and is configured to provide structural support and provide a cooling function to the at least one battery pack. The at least one superbeam includes a first face plate, a first passenger plate that partially abuts the first face plate, a first subchannel defined by the first face plate and the first passenger plate, a second passenger plate, a thermal barrier interlayer disposed between the first passenger plate and the second passenger plate, a second face plate opposite the first face plate, a second subchannel defined by the second face plate and the second passenger plate, and an inlet port and an outlet port extending through the superbeam. The first subchannel and the second subchannel are configured to carry a coolant. A portion of the first passenger plate and a portion of the second passenger plate define an air gap. The thermal barrier interlayer abuts a portion of the first passenger plate and the second passenger plate and extends into the air gap. The first passenger plate, the second passenger plate, and the thermal barrier interlayer are disposed between the first face plate and the second face plate. The inlet port and the outlet port are fluidly coupled with the first subchannel and the second subchannel.

In accordance with another aspect of the disclosure, the battery includes a superbeam formed of aluminum.

In accordance with another aspect of the disclosure, the battery includes a thermal barrier interlayer formed from at least one of a silicon dioxide (SiO₂)-based material or mica.

In accordance with another aspect of the disclosure, the battery includes a thermal barrier interlayer having a thickness between about 0.1 millimeters and about 1 millimeter.

In accordance with another aspect of the disclosure, the battery includes a second passenger plate stamped with a two-step structure. The two-step structure includes between about a 0.1 millimeter to about a 1 millimeter step.

In accordance with another aspect of the disclosure, the battery includes both a first passenger plate and a second passenger plate stamped with a two-step structure.

In accordance with another aspect of the disclosure, the battery includes two-step structures that include between about a 0.05 millimeter to a 0.5 millimeter step.

In accordance with another aspect of the disclosure, the battery further includes a washer located at each of the inlet port and the outlet port. The washer is disposed between the first passenger plate and the second passenger plate to form a clearance space in which a portion of the thermal barrier interlayer is disposed. The clearance space is defined by the first passenger plate, the second passenger plate, and the washer.

In accordance with another aspect of the disclosure, the battery includes a washer that is formed from aluminum.

According to several aspects of the present disclosure, an electric vehicle battery pack is provided. The electric vehicle battery pack includes at least one battery cell carried by a battery pack, at least one superbeam contained within the battery pack and disposed proximate to the at least one battery cell, a thermal insulating layer disposed between the at least one battery cells at a cell-to-cell side of the at least one battery cell, and a thermal conducting layer disposed between and abutting the at least one battery cell and the at least one superbeam. The thermal conducting layer is a thermal conductor.

In accordance with another aspect of the disclosure, the electric vehicle battery pack includes a superbeam formed of aluminum.

In accordance with another aspect of the disclosure, the electric vehicle battery pack includes a thermal insulating layer formed from at least one of silicone foam, aerogel, or mica.

In accordance with another aspect of the disclosure, the electric vehicle battery pack includes a thermal insulating layer having a plurality of layers including a first layer of mica, a second layer of silicone foam, and a third layer of mica.

In accordance with another aspect of the disclosure, the electric vehicle battery pack includes a thermal insulating layer having a plurality of layers including a first layer of silicone foam, a second layer of mica, and a third layer of silicone foam.

In accordance with another aspect of the disclosure, the electric vehicle battery pack includes a thermal insulating layer having a thickness between about 0.1 millimeters and about 1 millimeter.

According to several aspects of the present disclosure, a method for forming a superbeam is provided. The method includes placing a portion of a first passenger plate against a portion of a first face plate, placing a portion of a second passenger plate against a portion of the first passenger plate, and placing a portion of a second face plate against a portion of the second passenger plate. The first passenger plate and the first face plate define a first subchannel configured to carry a cooling fluid. The second passenger plate and the first passenger plate define a thermal gap, and a sacrificial material fills the thermal gap. The second passenger plate and the second face plate define a second subchannel for carrying the cooling fluid. The method also includes brazing the first face plate, the first passenger plate, the second passenger plate, and the second face plate, removing the sacrificial material to create an air gap defined by the first passenger plate and the second passenger plate, and filling the air gap with a filler material.

In accordance with another aspect of the disclosure, the method includes a superbeam formed of aluminum.

In accordance with another aspect of the disclosure, the method includes a sacrificial material including at least one of a water-soluble sand mold or a composite material.

In accordance with another aspect of the disclosure, the method includes using water to remove the sacrificial material.

In accordance with another aspect of the disclosure, the method further includes clamping the first passenger plate and the second passenger plate prior to a brazing step.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle having a battery pack including a cooled superbeam with a thermal barrier interlayer for preventing or minimizing TRP events, in accordance with the present disclosure.

FIG. 2 is a perspective view illustrating the superbeam in the vehicle battery pack shown in FIG. 1, where the superbeam includes a cooling subchannel, in accordance with the present disclosure.

FIG. 3 is a side cutaway view illustrating a portion of the superbeam shown in FIG. 2, where the superbeam includes the thermal barrier interlayer disposed in a clearance space created by a washer, in accordance with the present disclosure.

FIG. 4 is a side cross section view illustrating a portion of the superbeam shown in FIG. 2, where the superbeam includes the thermal barrier interlayer disposed in a clearance space created by a washer, in accordance with the present disclosure.

FIG. 5 is a side cross section view illustrating a portion of the superbeam shown in FIG. 2, where the superbeam includes the thermal barrier interlayer disposed in a clearance space created by a stamped passenger plate, in accordance with the present disclosure.

FIG. 6 is a side cross section view illustrating a portion of the superbeam shown in FIG. 2, where the superbeam includes an air gap disposed in a clearance space between a first passenger plate and a second passenger plate created by a stamped passenger plate and a sacrificial material, in accordance with the present disclosure.

FIG. 7 is a top view illustrating the battery pack shown in FIG. 1, where the battery pack includes thermal insulating layers between the battery cells and includes at least one superbeam having a thermal conducting layer disposed between the superbeam and the battery cells, in accordance with the present disclosure.

FIG. 8 is a flowchart illustrating a method for forming the superbeam as shown in FIG. 2, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

A battery pack is disclosed herein that includes a superbeam for providing structural support, elasticity to accommodate cell expansion during cycles, and TRP suppression enhancement. A multifunctional interlayer is disposed between subchannels in the superbeam that prevents hard connections during brazing processes and provides additional elasticity while acting as thermal insulation against thermal propagation. The interlayer barrier may include a thermal insulating material with fireproof capability for thermal management and is disposed between a portion of passenger plates to prevent hard connections during brazing.

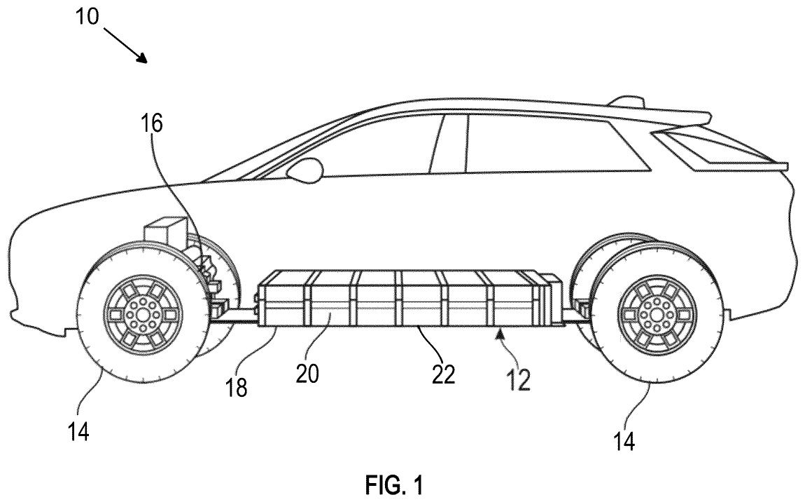

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 18 for supporting a plurality of battery cells 20. In an example, the battery pack 12 may have fifty or more battery cells 20. Additionally, at least one superbeam 22 is disposed between at least some of the battery cells 20.

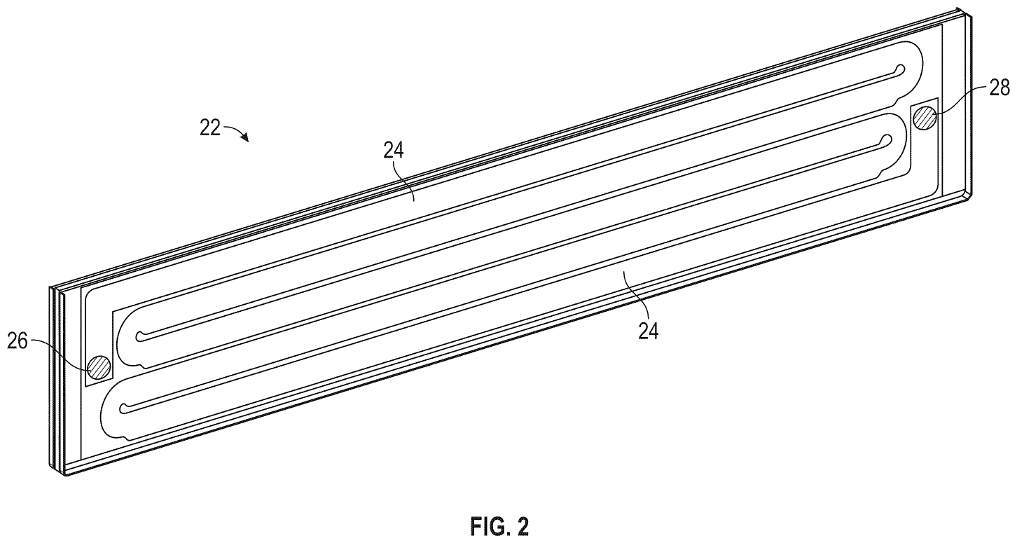

FIG. 2 illustrates a perspective view of the superbeam 22 shown in FIG. 1. The superbeam 22 has an elongated body and extends across and is configured to provide mechanical stability to case 18 of the battery pack 12. Additionally, the superbeam 22 is configured to provide TRP blocking and thermal cooling to the battery cells 20 as the battery cells 20 emit heat during use. Furthermore, the superbeam 22 is configured to provide a measure of elasticity to the battery cells 20 and battery pack 12 because the battery cells 20 may expand during cycles. The superbeam 22 generally comprises aluminum. However, the superbeam 22 may include or be formed of other suitable materials.

As shown in FIG. 2, the superbeam 22 includes at least one subchannel 24 extending through the superbeam 22 and configured to carry a coolant or cooling fluid. In this example, the subchannel 24 has an undulating or a wave configuration, although it will be appreciated that the subchannel 24 may have other configurations suitable for carrying the cooling fluid. The superbeam 22 also includes an inlet port 26 and an outlet port 28 through which the cooling fluid enters and exits the superbeam 22.

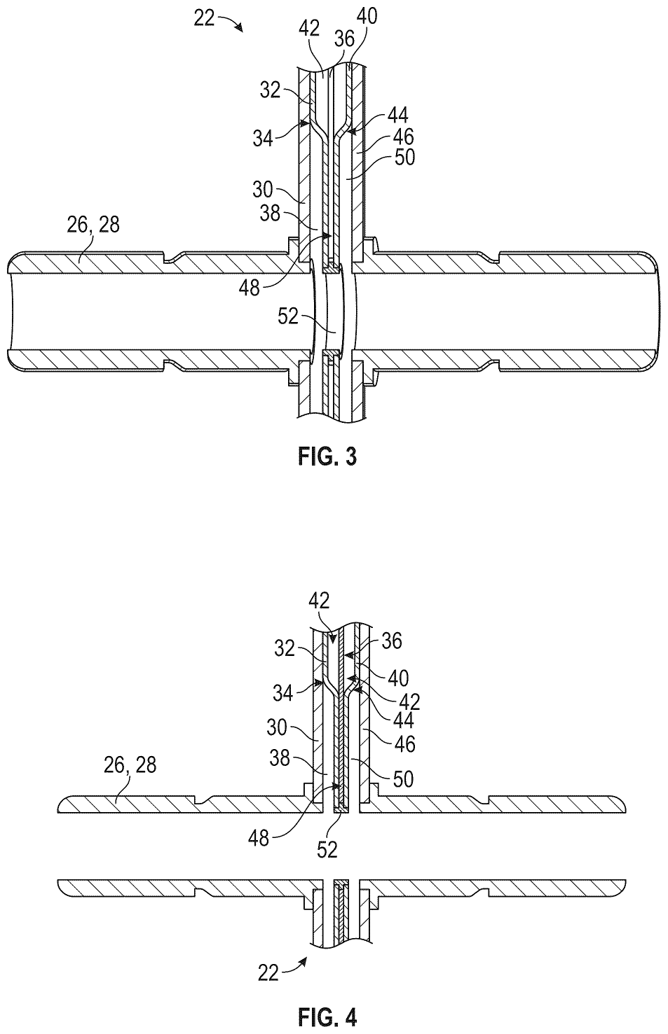

FIGS. 3 and 4 illustrates a cutaway view and a cross-section view, respectively, of a portion of the superbeam 22. The superbeam 22 includes a first face plate 30 that functions as one side of a first outer surface of the superbeam 22. A first passenger plate 32 has a first step 34 and at least partially abuts the first face plate 30. The first step 34 is located at a point where the first passenger plate 32 transitions from abutting a thermal barrier interlayer 36 to abutting the first face plate 30. The first face plate 30 and the first passenger plate 32 generally are formed from aluminum. A first subchannel 38 is at least partially defined by the first face plate 30 and the first passenger plate 32. The first subchannel 38 carries the cooling fluid from the inlet port 26 to the outlet port 28.

The superbeam 22 includes a second passenger plate 40. The first passenger plate 32 and the second passenger plate 40 define an air gap 42. The air gap 42 serves as a thermal insulation barrier. The second passenger plate 40 includes a second step 44. The second step 44 is located at a point where the second passenger plate 40 transitions from abutting the thermal barrier interlayer 36 to abutting a second face plate 46. The second passenger plate 40 is generally formed from aluminum, although the second passenger plate 40 may be formed from other suitable metals or materials.

A thermal barrier interlayer 36 is disposed between and abuts the first passenger plate XD and the second passenger plate 40. The thermal barrier interlayer 36 also extends from between the first passenger plate 32 and the second passenger plate 40 into the air gap 42. The thermal barrier interlayer 36 is formed of thermal insulating material with fireproof capability and is designed at a clearance 48 between the first passenger plate 32 and the second passenger plate 40 to prevent hard connections between the first passenger plate 32 and the second passenger plate 40 during a subsequent brazing process. A hard connection hinders thermal insulating qualities of the superbeam 22. Hard connections also reduce elasticity of the superbeam 22. In an example, the thermal barrier interlayer 36 is formed from a silicon dioxide (SiO₂)-based material (e.g., SiO₂ aerogel, silicone foam, and the like). It will be appreciated the thermal barrier interlayer 36 may be formed from other suitable materials, for example mica. In another example, the thermal barrier interlayer 36 may have a thickness between about 0.1 millimeters and about 1 millimeter. In this context, one of skill in the art would understand the term “about.” Alternatively, the term “about” means plus or minus 0.05 millimeters.

Referring still to FIGS. 3 and 4, the superbeam 22 includes the second face plate 46. The second face plate 46 is opposite the first face plate 30 and at least partly abouts the second passenger plate 40 to form a second outer surface of the superbeam 22. The first passenger plate 32, the second passenger plate 40, and the thermal barrier interlayer 36 are disposed between the first face plate 30 and the second face plate 46. A portion of the second face plate 46 and the second passenger plate 40 define a second subchannel 50 configured to carry the coolant or cooling fluid. The second subchannel 50 is parallel with and may be fluidly coupled with the first subchannel 38.

The superbeam 22 includes the inlet port 26. The inlet port 26 is configured to receive an inflow into the superbeam 22, the first subchannel 38, and the second subchannel 50. The inlet port 26 extends through the first face plate 30, the first passenger plate 32, the thermal barrier interlayer 36, the second passenger plate 40, and the second face plate 46. The inlet port 26 is also fluidly coupled with the first subchannel 38 and the second subchannel 50.

The superbeam 22 includes the outlet port 28. The outlet port 28 is configured to discharge the coolant from the superbeam 22, the first subchannel 38, and the second subchannel 50. The outlet port 28 extends through the first face plate 30, the first passenger plate 32, the thermal barrier interlayer 36, the second passenger plate 40, and the second face plate 46. The outlet port 28 is fluidly coupled with the first subchannel 38 and the second subchannel 50. The coolant flows from the inlet port 26 through the first subchannel 38 and the second subchannel 50 and out of the outlet port 28.

In one example, and as illustrated in FIGS. 3 and 4, the superbeam 22 includes a washer 52. The washer 52 is located at each of the inlet port 26 and the outlet port 28. The washer 52 is disposed between the first passenger plate 32 and the second passenger plate 40 to form a clearance 48 between the first passenger plate 32 and the second passenger plate 40. The clearance 48 is designed to create a space between the first passenger plate 32 and the second passenger plate 40 in which the thermal barrier interlayer 36 is disposed. The clearance 48 is defined by the washer 52, the first passenger plate 32, and the second passenger plate 40. The washer 52 may be formed of aluminum or the same or similar material from which the first passenger plate 32 and the second passenger plate 40 are formed. In the example shown in FIGS. 3 and 4, the washer 52 is in a circumferential ring-like configuration and is configured so that coolant may flow through the washer 52.

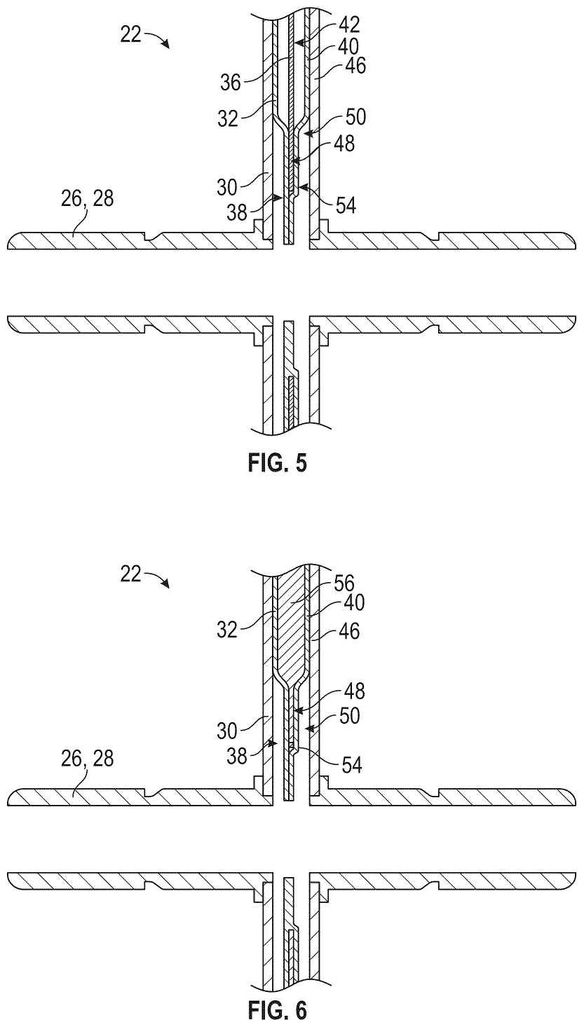

Referring to FIG. 5, the superbeam 22 includes a first face plate 30, a first passenger plate 32, a thermal barrier interlayer 36, a second passenger plate 40, and a second face plate 46. In this example, the second passenger plate 40 includes a stamped step 54. The stamped step 54 is configured to provide a clearance 48 between the first passenger plate 32 and the second passenger plate 40, where the thermal barrier interlayer 36 is disposed between the first passenger plate 32 and the second passenger plate 40 inside the clearance 48. In the example shown in FIG. 5, only the second passenger plate 40 has a stamped step 54. In this example, the second passenger plate 40 may include a stamped thickness between about 0.1 millimeters to about 1 millimeter. It will be appreciated, though the second passenger plate 40 includes the stamped step 54 shown in FIG. 5, that the first passenger plate 32 may include the stamped step 54, and the stamped step 54 may include a stamped thickness between about 0.1 millimeters to about 1 millimeter. In another example (not shown), both the first passenger plate 32 and the second passenger plate 40 may include a stamped step 54. In this example, the stamped step 54 on the first passenger plate 32 may be opposite from but parallel to the stamped step 54 on the second passenger plate 40, and the stamped thickness on both the first passenger plate 32 and the second passenger plate 40 may be between about 0.05 millimeters to a 0.5 millimeter step, which results in a clearance 48 of between about 0.1 millimeters and about 1 millimeter. In this context, one of skill in the art would understand the term “about.” Alternatively, the term “about” means plus or minus 0.05 millimeters.

FIG. 6 illustrates a superbeam 22 having a clearance 48 and air gap formed using a sacrificial material and filled with a filler material 56. The superbeam 22 includes the first face plate 30, the first passenger plate 32, the second passenger plate 40, and the second face plate 46. In this example, the first passenger plate 32 and/or the second passenger plate 40 includes a stamped step 54. During fabrication, the sacrificial material may be placed between the first passenger plate 32 and the second passenger plate 40 to create the clearance 48. After a subsequent brazing step, the sacrificial material is removed. The sacrificial material is designed to maintain dimensions of the air/thermal gap during the brazing step. One example of the sacrificial material may include a water-soluble sand mold. It will be appreciated that the sacrificial material may include other materials suitable to withstand heat from the brazing step. Subsequent to removing the sacrificial material, the air gap 42 may be filled with the filler material 56 designed to maintain the clearance 48 and gap between the first passenger plate 32 and the second passenger plate 40. Some examples of a filler material 56 include foam, polyethylene, a composite material, and the like. In some instances, for example when the first subchannel 38 and/or the second subchannel 50 are arc-shaped, the filler material 56 may be difficult to fix and locate, and the first face plate 30 and the second face plate 46 may be clamped together to provide fixture.

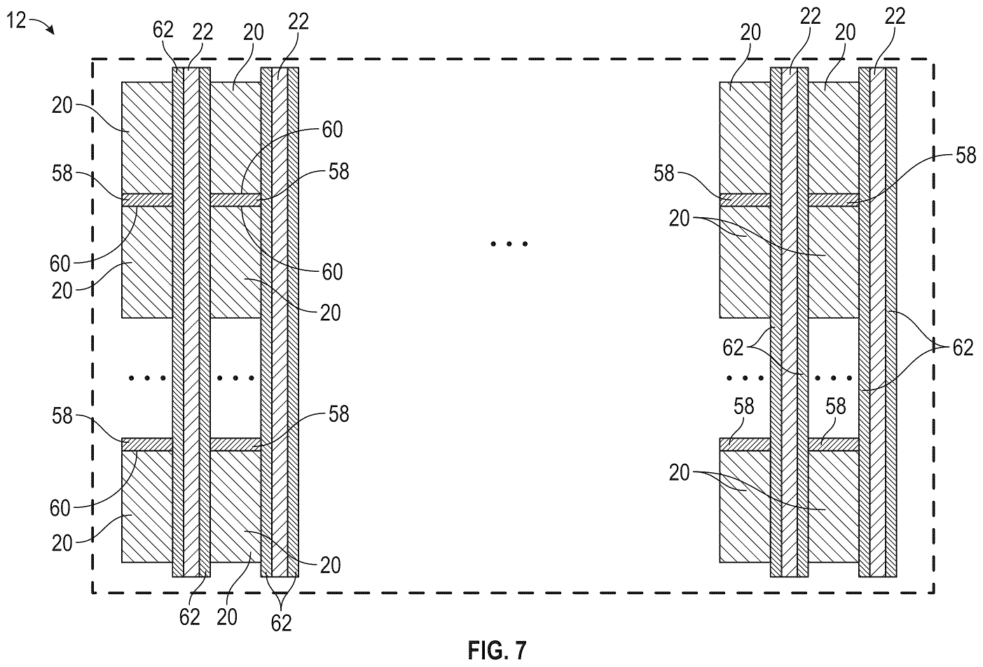

FIG. 7 illustrates the battery pack 12 with at least one superbeam 22 and a plurality of battery cells 20. In this example, a thermal insulating layer 58 is disposed between each battery cell 20 at a cell-to-cell side 60 of each battery cell 20. The thermal insulating layer 58 is configured to insulate each battery cell 20 from heat produced from a neighboring battery cell and to prevent or minimize TRP. The thermal insulating layer 58 may include materials that are good thermal insulators with low thermal conductivity but have no or limited elasticity. In examples, the thermal insulating layer 58 may include good thermal insulators, for example, silicone foam, SiO₂ aerogel, mica, and the like. In some instances, the thermal insulating layer 58 may include multiple layers in a sandwich-like configuration (e.g., a mica/silicone foam/mica sandwich, a silicone foam/mica/silicone foam sandwich, and so forth). The thermal insulating layer 58 may have a thickness between about 0.1 millimeters and about 1 millimeter. In this context, one of skill in the art would understand the term “about.” Alternatively, the term “about” means plus or minus 0.05 millimeters.

Still referring to FIG. 7, the battery pack 12 also includes a thermal conducting layer 62 disposed between and abutting each battery cell 20 and the superbeam 22. The thermal conducting layer 62 is configured to have good thermal conductivity and conduct heat from the battery cells 20 to the superbeam 22 and the coolant in the first subchannel 38 and/or the second subchannel 50. In some examples, the thermal conducting layer 62 may be formed from aluminum. It is contemplated that a small air gap may be disposed between the thermal conducting layer 62 and at least one of the battery cells 20. Additionally, each side of the superbeam 22 facing a battery cell 20 may include a thermal conducting layer 62.

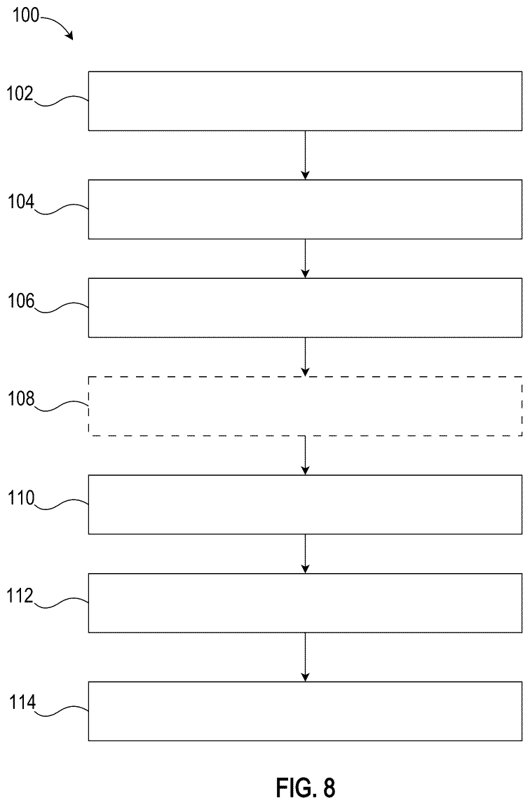

With reference to FIG. 8, a method 100 for forming the superbeam 22 is presented, in accordance with the present disclosure. The method starts at block 102.

Block 102 depicts placing a portion of the first passenger plate 32 against a portion of the first face plate 30. The first passenger plate 32 may be stepped and include a stamped or formed step. The first passenger plate 32 and the first face plate 30 define a first subchannel 38 to carry the cooling fluid.

Next, block 104 depicts placing a portion of the second passenger plate 40 against a portion of the first passenger plate 32. The second passenger plate 40 may be stepped and include a step. The second passenger plate 40 and the first passenger plate 32 define a thermal gap or air gap 42. The sacrificial material fills the thermal gap.

Then, block 106 depicts placing a portion of the second face plate 46 against a portion of the second passenger plate 40. The second passenger plate 40 and the second face plate 46 define a second subchannel 50 for carrying the cooling fluid.

In some instances, and in an optional step, block 108 depicts clamping together the first face plate 30, the first passenger plate 32, the second passenger plate 40, and the second face plate 46 prior to a brazing step.

Block 110 depicts brazing the first face plate 30 the first passenger plate 32, the second passenger plate 40, and the second face plate 46 to couple and fasten each of the plates to form the superbeam 22.

Block 112 depicts removing the sacrificial material to create an air gap or a thermal gap defined by the first passenger plate 32 and the second passenger plate 40. Removing the sacrificial material may include, for example, using water to dissolve and/or wash the sacrificial material from the thermal gap or air gap.

Block 114 depicts filling the air gap with a filler material. The filler material may include, for example, a foam that can be injected into the air gap. The filler material may be fluid for ease of filling the air gap and may have a low thermal conductivity.

The superbeam 22 of the present disclosure is advantageous and beneficial over prior art solutions. The superbeam 22 provides structural support, elasticity compensation, and TRP suppression enhancement for the battery pack 12 described herein. The thermal barrier interlayer 36 is a multifunctional interlayer that prevents hard connections during brazing processes and provides additional elasticity while acting as thermal insulation against thermal propagation for thermal management.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery for an electric vehicle, comprising:
a battery pack housing;
at least one battery pack carried by the battery pack housing; and
at least one superbeam contained within the battery pack housing and configured to provide structural support and to provide a cooling function to the at least one battery pack, wherein the at least one superbeam has an elongated body and includes
a first face plate;
a first passenger plate that partially abuts the first face plate;
a first subchannel defined by the first face plate and the first passenger plate, where the first subchannel is configured to carry a coolant;
a second passenger plate, wherein a portion of the first passenger plate and a portion of the second passenger plate define an air gap;
a thermal barrier interlayer disposed between the first passenger plate and the second passenger plate, wherein the thermal barrier interlayer abuts a portion of the first passenger plate and the second passenger plate and extends into the air gap;
a second face plate opposite the first face plate, wherein the first passenger plate, the second passenger plate, and the thermal barrier interlayer are disposed between the first face plate and the second face plate;
a second subchannel defined by the second face plate and the second passenger plate, where the second subchannel is configured to carry the coolant; and
an inlet port and an outlet port extending through the superbeam, where the inlet port and the outlet port are fluidly coupled with the first subchannel and the second subchannel.

2. The battery for the electric vehicle in claim 1, wherein the superbeam is formed of aluminum.

3. The battery for the electric vehicle in claim 1, wherein the thermal barrier interlayer is formed from at least one of a SiO₂-based material or mica.

4. The battery for the electric vehicle in claim 1, wherein the thermal barrier interlayer has a thickness between about 0.1 millimeters and about 1 millimeter.

5. The battery for the electric vehicle in claim 1, wherein the second passenger plate is stamped with a two-step structure, and wherein the two-step structure includes between about a 0.1 millimeter to about a 1 millimeter step.

6. The battery for the electric vehicle in claim 5, wherein both the first passenger plate and the second passenger plate are stamped with a two-step structure.

7. The battery for the electric vehicle in claim 5, wherein the two-step structures include between about a 0.05 millimeter to a 0.5 millimeter step.

8. The battery for the electric vehicle in claim 1, further comprising:
a washer located at each of the inlet port and the outlet port, wherein the washer is disposed between the first passenger plate and the second passenger plate to form a clearance space in which a portion of the thermal barrier interlayer is disposed, and wherein the clearance space is defined by the first passenger plate, the second passenger plate, and the washer.

9. The battery for the electric vehicle in claim 8, wherein the washer is formed from aluminum.

10. An electric vehicle battery pack, comprising:
at least one battery cell carried by a battery pack;
at least one superbeam contained within the battery pack and disposed proximate to the at least one battery cell;
a thermal insulating layer disposed between the at least one battery cells at a cell-to-cell side of the at least one battery cell; and
a thermal conducting layer disposed between and abutting the at least one battery cell and the at least one superbeam, wherein the thermal conducting layer is a thermal conductor.

11. The electric vehicle battery pack in claim 10, wherein the superbeam is formed of aluminum.

12. The electric vehicle battery pack in claim 10, wherein the thermal insulating layer is formed from at least one of silicone foam, aerogel, or mica.

13. The electric vehicle battery pack in claim 10, wherein the thermal insulating layer has a plurality of layers including a first layer of mica, a second layer of silicone foam, and a third layer of mica.

14. The electric vehicle battery pack in claim 10, wherein the thermal insulating layer has a plurality of layers including a first layer of silicone foam, a second layer of mica, and a third layer of silicone foam.

15. The electric vehicle battery pack in claim 10, wherein the thermal insulating layer has a thickness between about 0.1 millimeters and about 1 millimeter.

16. A method for forming a superbeam, comprising:
placing a portion of a first passenger plate against a portion of a first face plate, wherein the first passenger plate and the first face plate define a first subchannel configured to carry a cooling fluid;
placing a portion of a second passenger plate against a portion of the first passenger plate, wherein the second passenger plate and the first passenger plate define a thermal gap, and wherein a sacrificial material fills the thermal gap;
placing a portion of a second face plate against a portion of the second passenger plate, wherein the second passenger plate and the second face plate define a second subchannel for carrying the cooling fluid;
brazing the first face plate, the first passenger plate, the second passenger plate, and the second face plate;
removing the sacrificial material to create an air gap defined by the first passenger plate and the second passenger plate; and
filling the air gap with a filler material.

17. The method of claim 16, wherein the superbeam is formed of aluminum.

18. The method of claim 16, wherein the sacrificial material includes at least one of a water-soluble sand mold or a composite material.

19. The method of claim 16, wherein removing the sacrificial material includes using water to remove the sacrificial material.

20. The method of claim 16, further comprising:
clamping the first passenger plate and the second passenger plate prior to a brazing step.
